(19) United States
(12) Patent Application Publication
(10) Pub. No.: US 2025/0388222 A1
(43) Pub. Date: Dec. 25, 2025

(54) CONTROL DEVICE, CONTROL METHOD, AND RECORDING MEDIUM

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/241,724

(22) Filed: Jun. 18, 2025

(30) Foreign Application Priority Data
Jun. 25, 2024 (JP) 2024-101693
Jun. 25, 2024 (JP) 2024-101725

(51) Int. Cl. B60W 50/02; B60R 1/23

(52) U.S. Cl. CPC B60W 50/0225; B60R 1/23; B60W 50/0205; B60W 2520/06; B60W 2520/10

(57) ABSTRACT

A control device provided to a vehicle includes: a first obtainer that obtains, from a user application, a control request for controlling a vehicle device of the vehicle; a second obtainer that obtains a vehicle status of the vehicle; and a determiner that determines whether to approve the control request, based on the vehicle status.

### CROSS REFERENCE TO RELATED APPLICATIONS

The present application is based on and claims priority of Japanese Patent Applications Nos. 2024-101693 filed on Jun. 25, 2024 and 2024-101725 filed on Jun. 25, 2024.

### FIELD

The present disclosure relates to a control device included in a vehicle, a control method, and a recording medium.

### BACKGROUND

Patent Literature (PTL) 1 discloses a technique capable of preventing unnecessary execution of an application that is not required for an intended use of a vehicle that enables vehicle devices to execute various kinds of applications.

### CITATION LIST

### Patent Literature

### PTL 1:

Japanese Unexamined Patent Application Publication No. 2014-233998

### PTL 2:

Japanese Unexamined Patent Application Publication No. 2014-220636

### SUMMARY

However, control devices of the above related arts can be improved upon.

In response to this, the present disclosure provides a control device, a control method, and a recording medium that are capable of improving upon the related arts.

According to an aspect of the present disclosure, a control device provided to a vehicle includes: a first obtainer that obtains, from a user application, a control request for controlling a vehicle device of the vehicle; a second obtainer that obtains a vehicle status of the vehicle; and a determiner that determines whether to approve the control request, based on the vehicle status.

According to another aspect of the present disclosure, a control method executed by a control device provided to a vehicle includes: obtaining, from a user application, a control request for controlling a vehicle device of the vehicle; obtaining a vehicle status of the vehicle; and determining whether to approve the control request, based on the vehicle status.

According to still another aspect of the present disclosure, a non-transitory computer-readable recording medium having recorded thereon a computer program causes a computer to execute the control method described above.

One aspect of the present disclosure enables a control device and so forth to improve upon the related arts.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a vehicle that includes a control device according to Embodiment 1.

FIG. 2 is a flowchart of an operation performed by the control device according to Embodiment 1.

FIG. 3 is a block diagram illustrating a configuration of a vehicle that includes a control device according to Embodiment 2.

FIG. 4 is a flowchart of an operation performed by the control device according to Embodiment 2.

### DESCRIPTION OF EMBODIMENTS

### (Circumstances Leading to the Present Disclosure)

Before the embodiments according to the present disclosure are described, circumstances leading to the present disclosure are first described.

It is expected that, in the future, a function can be added to a vehicle using a user application, as with a smartphone for example. More specifically, it is expected that control over a vehicle device is released to a user application and control requests are outputted from the user application to the vehicle device. A function to be released may be a function that is not directly connected to a life-or-death situation for an occupant of the vehicle. Hereinafter, an application (an application program) may also be referred to as an app and a user application may also be referred to as a user app.

The user app is different from an app (a system application) that is preinstalled in the vehicle. Examples of the user app include an app executable by an operation (or a contract) of a user and an app installed by the user. The user app may be an app for enabling a function that achieves higher performance than a function enabled by the system application, for example. The user app is an app for controlling a vehicle device targeted for control by the system application, in place of or together with the system application.

When such a user app is used, it is desirable that the vehicle device be safely controlled by the user app. However, depending on a vehicle status, such as when the vehicle is traveling or crossing an intersection, the use of the user app may place the vehicle in a dangerous state. Furthermore, examples of such a user app may include an app for executing an operation unintended by the manufacturer and an app that is beyond control. Approving all control requests for controlling the vehicle device from such user apps may compromise the safety of the vehicle. Rejecting all control requests for controlling the vehicle device from such user apps may reduce the user values of the user apps. On this account, it is desirable that a control request from a user app be approved when appropriate and rejected when inappropriate. More specifically, it is desirable that whether to approve a control request for controlling a vehicle device from a user app is determined more appropriately. However, PTL 1 does not disclose such a technique.

In response to this, the present inventors have diligently studied a control device and so forth capable of more appropriately determining whether to approve a control request for controlling a vehicle device from a user app. As a result, the present inventors have invented a control device and so forth described below as further improvement upon the above related arts. To be more specific, the present inventors have invented the control device and so forth that are capable of approving or blocking a control request for controlling a vehicle device from a user app, based on a vehicle status.

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should be noted that each figure in the Drawings is a schematic diagram and is not necessarily an exact diagram. Therefore, the reduced scale and the like of each figure are not necessarily correct. In each figure, substantially identical constituent elements are assigned with a same reference sign, and explanation of such substantially identical constituent elements is sometimes not repeated or simplified.

It should be noted that the following description may include numerical values and numerical value ranges. However, such numerical values and numerical value ranges do not mean exact meanings only. They also mean the substantially same ranges including a difference of, for example, about several % (or about 10%) from the completely same range.

It should be noted that the following description may include ordinal numbers, such as “first” and “second”. However, such ordinal numbers do not mean the number or order of the constituent elements. Unless otherwise described, they are used to distinguish the same type of constituent elements from each other to avoid confusion.

### Embodiment 1

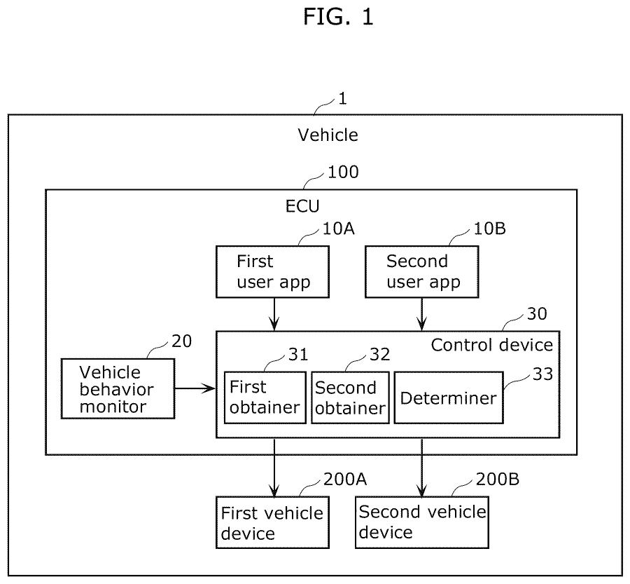

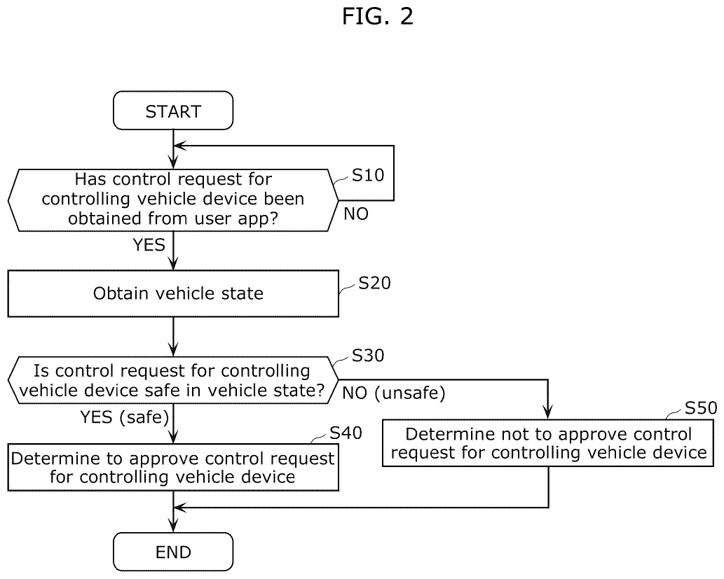

The following describes a control device according to the present embodiment with reference to FIG. 1 and FIG. 2.

### [1-1. Configuration of Control Device]

A configuration of a vehicle that includes the control device according to the present embodiment is first described with reference to FIG. 1. FIG. 1 is a block diagram illustrating a configuration of vehicle 1 that includes control device 30 according to the present embodiment. Note that FIG. 1 illustrates an exemplary functional configuration of control device 30 and that the functional configuration of control device 30 is not limited to the configuration illustrated in FIG. 1.

As illustrated in FIG. 1, vehicle 1 includes electronic control unit (ECU) 100, first vehicle device 200A, and second vehicle device 200B. Note that the number of vehicle devices included in vehicle 1 is not limited to two and may be one or more.

ECU 100 is an in-vehicle ECU that is included in vehicle 1, and performs control on a vehicle device (equipment) included in vehicle 1. For example, ECU 100 is a device that includes a digital circuit, an analog circuit, and a communication circuit, such as a processor (microprocessor) and a memory. Examples of the memory include a read only memory (ROM) and a random access memory (RAM). The memory is capable of storing a control program (computer program) executed by the processor. Each of various functions of ECU 100 is achieved by the processor operating according to the control program (computer program). This control program includes the aforementioned user app.

Note that vehicle 1 includes a plurality of ECUs 100. For example, the plurality of ECUs 100 are communicatively connected with each other via an in-vehicle communication network (or more specifically, a bus connected to each of these ECUs). At least one of the plurality of ECUs 100 may have the configuration illustrated in FIG. 1.

ECU 100 may be an ECU (a so-called zone ECU) that is disposed in vehicle 1 and that controls a vehicle device in a zone where this ECU is disposed. Alternatively, ECU 100 may be a central ECU (a so-called integrated ECU) that combines a plurality of ECUs. To eliminate the issues of development period and cost that increase as an in-vehicle system increases in complexity, functions that have been conventionally installed separately on a plurality of ECUs are combined into the integrated ECU. The integrated ECU uses virtualization technique that allows a plurality of virtual computers (virtual machines: VM) to operate in one ECU.

ECU 100 functions as control equipment that controls the vehicle device by executing the installed user app. ECU 100 includes first processor 10A, second processor 10B, vehicle behavior monitor 20, and control device 30. Note that the number of user apps included in ECU 100 is not limited to two and may be one or more. ECU 100 also includes a system application (not shown). Hereinafter, the system application is also referred to as the system app. The system app may be included in the aforementioned control program. Moreover, ECU 100 may further include a processor (not shown) that executes the system app.

Each of first processor 10A and second processor 10B is a processor that executes a user app different from the system app. To be more specific, first processor 10A is the processor that executes “First user app” illustrated in FIG. 1, and second processor 10B is the processor that executes “Second user app” illustrated in FIG. 1.

The user app is created by a company different from a manufacturer of the system app, for example. Each of first processor 10A and second processor 10B is capable of controlling the vehicle device of vehicle 1 by executing the user app. Each of first processor 10A and second processor 10B outputs, to control device 30, a control request for controlling the vehicle device of vehicle 1. When control device 30 approves the control request, the corresponding one of first processor 10A and second processor 10B is allowed to control this vehicle device. The control request includes: identification information (such as an ID) identifying the vehicle device targeted for control; and a control detail.

First processor 10A and second processor 10B are the apps that control respective vehicle devices that are different from each other. However, first processor 10A and second processor 10B may be the apps that control the same vehicle device, for example. The following describes an example where first processor 10A controls first vehicle device 200A and second processor 10B controls second vehicle device 200B.

As described above, ECU 100 according to the present embodiment has the configuration that enables the user app to operate.

Vehicle behavior monitor 20 has a function of monitoring vehicle behavior, and monitors a vehicle status including the vehicle behavior. Vehicle behavior monitor 20 may monitor the vehicle status by obtaining sensing data from a plurality of sensors included in vehicle 1. Examples of the plurality of sensors include, but are not limited to, a speed sensor, an acceleration sensor, a position sensor (such as a global positioning system (GPS) sensor), a steering angle sensor, a camera, an obstacle sensor, and an illuminance sensor. The camera may be a camera that images the inside of vehicle 1 or a camera that images the outside of vehicle 1. The obstacle sensor is a sensor that detects an obstacle present in the vicinity of vehicle 1 using, for example, light detection and ranging (LIDAR). However, the obstacle sensor is not limited to this. The illuminance sensor may measure outdoor illuminance or indoor illuminance.

Vehicle behavior monitor 20 obtains, from the plurality of sensors, at least one of a speed, a position, a steering angle, a traveling direction, or a surrounding environment of vehicle 1, as the vehicle status. Furthermore, vehicle behavior monitor 20 may obtain (for example, determine) the vehicle status from the speed, based on whether vehicle 1 is traveling at a low speed, traveling at a high speed, or stationary. At the low speed, vehicle 1 may be traveling at a speed lower than a threshold value. At the high speed, vehicle 1 may be traveling at a speed higher than or equal to the threshold value. Furthermore, vehicle behavior monitor 20 may obtain (for example, determine) the vehicle status from the position, based on whether vehicle 1 is traveling in a predetermined location or whether vehicle 1 is traveling in a predetermined area. For example, vehicle behavior monitor 20 is able to determine, from the position, whether vehicle 1 is crossing an intersection or whether vehicle 1 is crossing a crosswalk.

Furthermore, vehicle behavior monitor 20 may obtain (for example, determine) the vehicle status from the steering angle, based on whether vehicle 1 is rounding a curve or traveling straight. Furthermore, vehicle behavior monitor 20 may obtain (for example, determine) the vehicle status from the traveling direction, based on whether vehicle 1 is moving forward or in reverse. Furthermore, vehicle behavior monitor 20 may obtain (for example, determine) the vehicle status from an illuminance value of the illuminance sensor, based on whether vehicle 1 is in a dark environment. Furthermore, vehicle behavior monitor 20 may obtain (for example, determine) the vehicle status from the shift lever, based on whether vehicle 1 is in a parking mode. Furthermore, vehicle behavior monitor 20 may obtain a current traveling mode of vehicle 1 as the vehicle status. Examples of the traveling mode include an automated driving mode and a vehicle-following mode provided by, for example, adaptive cruise control (ACC). Furthermore, the parking mode may be included in the traveling mode. Vehicle behavior monitor 20 may obtain the vehicle status, based on whether vehicle 1 is driven automatically or whether vehicle 1 is traveling under ACC.

Control device 30 determines whether to approve the control request from first processor 10A or second processor 10B, based on the vehicle status. Control device 30 includes first obtainer 31, second obtainer 32, and determiner 33. Hereinafter, the control request outputted when first processor 10A executes the first user app is also referred to as the control request from the first user app, and the control request outputted when second processor 10B executes the second user app is also referred to as the control request from the second user app.

First obtainer 31 is a communication interface that obtains a control request for controlling a vehicle device from a corresponding one of the first user app or the second user app. For example, first obtainer 31 obtains the control request for controlling first vehicle device 200A from the first user app and obtains the control request for controlling second vehicle device 200B from the second user app. However, this is not intended to be limiting. For example, first obtainer 31 includes a communication circuit (or a communication module).

Second obtainer 32 is a communication interface that obtains the vehicle status of vehicle 1 from vehicle behavior monitor 20. For example, second obtainer 32 obtains the vehicle status of vehicle 1 as of when first obtainer 31 obtains the control request. For example, second obtainer 32 includes a communication circuit (or a communication module).

Determiner 33 determines whether to approve the control request obtained by first obtainer 31, based on the vehicle status obtained by second obtainer 32. Determiner 33 determines whether to approve the control request, based on whether execution of the control request in the vehicle status places vehicle 1 in a dangerous state (for example, a state where traveling of vehicle 1 is dangerous). For example, when the execution of the control request in the vehicle status is predicted to place vehicle 1 in a dangerous state, determiner 33 determines not to approve the control request.

Furthermore, determiner 33 is capable of determining whether the control request obtained by first obtainer 31 is from the user app or from the system app. For example, assume that the user app does not have a predetermined privilege (a system privilege, for example) and the system app has the predetermined privilege (the system privilege, for example). In this case, depending on whether an output source of the control request is an app that has the predetermined privilege, determiner 33 may distinguish whether the control request is from the user app or from the system app. When the control request is from the system app, determiner 33 approves this control request regardless of the vehicle status.

Each of first vehicle device 200A and second vehicle device 200B is an in-vehicle device that is communicatively connected to ECU 100 via the in-vehicle communication network and that is controlled by ECU 100. Each of first vehicle device 200A and second vehicle device 200B is a physical device included in vehicle 1. Examples of first vehicle device 200A and second vehicle device 200B include a light (a headlight, for example), a display device, an electronic mirror, and an interior light. The display device may be included in a car navigation system or may be a rearview monitor, for example. Examples of first vehicle device 200A and second vehicle device 200B may also include a power window, an air conditioner, a lock-unlock device, and an audio device. Furthermore, first vehicle device 200A and second vehicle device 200B may be the in-vehicle devices that are of the same kind or different kinds.

### [1-2. Operation of Control Device]

Next, an operation of control device 30 having the configuration as above is described with reference to FIG. 2. FIG. 2 is a flowchart of the operation (a control method) performed by control device 30 according to the present embodiment.

As illustrated in FIG. 2, first obtainer 31 determines whether a control request for controlling a vehicle device has been obtained from a user app (S10). When the control request has been obtained from the first user app or the second user app, first obtainer 31 determines “YES” in Step S10. Note that when first obtainer 31 has obtained the control request from the system app, first obtainer 31 determines “NO” in Step S10. When first obtainer 31 determines “NO” in Step S10, first obtainer 31 returns to Step S10 and continues the processing.

Next, when first obtainer 31 determines that the control request for controlling the vehicle device has been obtained from the user app (YES in S10), that is, when first obtainer 31 has obtained the control request for controlling the vehicle device from the user app, second obtainer 32 obtains the vehicle status of vehicle 1 from vehicle behavior monitor 20 (S20). Note that although obtaining the vehicle status is triggered by obtaining the control request by first obtainer 31 from the user app, this is not intended to be limiting. For example, the vehicle status may be obtained periodically or when the vehicle status changes.

Next, determiner 33 determines whether the control request for controlling the vehicle device in the vehicle status (for example, the current vehicle status) obtained by second obtainer 32 is safe (S30). Determiner 33 determines whether execution of the control request in the vehicle status places vehicle 1 in a dangerous state (that is, vehicle 1 is safe or not). Examples of the dangerous state of vehicle 1 include a state where traveling of vehicle 1 is dangerous.

The following are specific examples of the determination made by determiner 33 as to whether it is safe.

For example, when the vehicle status includes traveling and the control request from the user app includes switching beams of the headlight of vehicle 1, determiner 33 determines that the beam switching of the headlight places vehicle 1 in a dangerous state and thus determines not to approve the control request. Examples of beam switching of the headlight include switching high and low beams from one to the other. For example, when the speed of vehicle 1 is greater than or equal to a threshold value and the control request from the user app includes beam switching of the headlight of vehicle 1, determiner 33 determines not to approve the control request. For example, when the control request from the user app is beam switching of the headlight of vehicle 1, determiner 33 may determine that it is not safe when vehicle 1 is traveling at a high speed and may determine that it is safe when vehicle 1 is traveling at a low speed.

Furthermore, for example, when the vehicle status includes moving in reverse and the control request from the user app includes superimposing a display item on the rearview monitor, determiner 33 determines that the superimposing of the display item places vehicle 1 in a dangerous state and thus determines not to approve the control request. Examples of the superimposing of the display item on the rearview monitor include superimposing a pop-up on the rearview monitor while vehicle 1 is moving in reverse. For example, when the control request from the user app includes superimposing of a display item on the rearview monitor of vehicle 1, determiner 33 may determine that it is not safe when vehicle 1 is moving in reverse and may determine that it is safe when vehicle 1 is not moving in reverse.

Furthermore, for example, when the vehicle status includes traveling in a dark environment and the control request from the user app includes turning on the interior light, determiner 33 determines that turning on the light makes it difficult for the driver to look ahead and thereby places vehicle 1 in a dangerous state. Thus, determiner 33 determines not to approve the control request. Whether vehicle 1 is in a dark environment can be determined based on an illuminance value measured by the illuminance sensor. In this way, the surrounding environment of vehicle 1 is also included in the vehicle status. For example, when the control request from the user app includes turning on the interior light of vehicle 1, determiner 33 may determine that it is not safe when vehicle 1 is traveling in a dark environment and may determine that it is safe when vehicle 1 is traveling in a bright environment.

Furthermore, for example, when the vehicle status includes traveling and the control request from the user app includes displaying an image to the driver of vehicle 1, determiner 33 determines that the displaying of the image divides attention of the driver and thereby places vehicle 1 in a dangerous state. Thus, determiner 33 determines not to approve the control request. For example, when the control request from the user app includes displaying an image to the driver of vehicle 1, determiner 33 may determine that it is not safe when vehicle 1 is traveling and may determine that it is safe when vehicle 1 is stationary. Note that the image may be a moving image or a still image.

Furthermore, for example, assume that: vehicle 1 includes an electronic mirror switchable between a video displaying function and a mirror function; the vehicle status includes traveling; and the control request from the user app includes turning on the mirror function of the electronic mirror. In this case, determiner 33 determines that the driver neglects to look ahead and that vehicle 1 is thereby placed in a dangerous state. Thus, determiner 33 determines not to approve the control request. The mirror function is a function of displaying an image captured by an in-vehicle camera on the electronic mirror. For example, this function is used when an occupant of the vehicle checks the occupant's appearance. For example, when the control request from the user app includes turning on the mirror function of the electronic mirror, determiner 33 may determine that it is not safe when vehicle 1 is traveling and may determine that it is safe when vehicle 1 is stationary.

A determination method used by determiner 33 to make the determination described above is not intended to be particularly limiting. For example, determiner 33 may make the determination described above, by reference to a table in which the vehicle status, the control request, and whether it is safe (that is, whether to approve the control request) are associated with each other. This table is created beforehand and stored in a storage (not shown) included in vehicle 1. Although the storage is implemented by a semiconductor memory or a hard disk drive (HDD) for example, this is not intended to be limiting. Furthermore, for example, determiner 33 may make the determination described above by inputting the obtained vehicle status and the obtained control request into a machine learning model. This machine learning model has been trained by machine learning using input data on vehicle statuses and control requests and using correct answer data on whether it is safe.

Next, when determiner 33 has determined that the control request for controlling the vehicle device in the vehicle status is safe (YES in S30), that is, has determined that vehicle 1 is safe, determiner 33 determines to approve the control request (S40) and then outputs the control request to the vehicle device targeted for control. For example, determiner 33 transfers the control request to the vehicle device targeted for control.

As a result, when vehicle 1 is safe, the control request from the user app is executed by the vehicle device targeted for control. Thus, the user value of the user app can be increased while the safety of vehicle 1 is ensured. Note that when it is determined as “YES” in Step S30, this means that vehicle 1 is determined to be safe.

Furthermore, when determiner 33 has determined that the control request for controlling the vehicle device in the vehicle status is not safe (NO in S30), that is, has determined that vehicle 1 is not safe (unsafe), determiner 33 determines not to approve the control request (S50) and does not output the control request to the vehicle device targeted for control. In other words, determiner 33 prohibits outputting the control request to the vehicle device targeted for control.

In this way, determiner 33 is able to block the control request for controlling the vehicle device from the user app when necessary, based on the vehicle status of vehicle 1. When vehicle 1 is to be placed in a dangerous state, the control request from the user app is not executed. Hence, the safety of vehicle 1 is ensured.

### Embodiment 2

### (Circumstances Leading to the Present Embodiment)

Before the present embodiment is described, circumstances leading to the present embodiment are first described. Note that, hereinafter, a system application is also referred to as a system app.

In a vehicle (in an ECU, for example), a plurality of apps are assumed to run. Thus, a plurality of apps can possibly make control requests concurrently for controlling the same vehicle device, for example. When the control requests are made concurrently, this means that two control requests may be to be executed at the same time. In this case, while one control request is being executed, the other control request may be obtained, for example. Alternatively, the control requests for controlling the same vehicle device may be obtained at the same time (or within a short time period). The concurrent control requests for controlling the same vehicle device from the plurality of apps may cause an unstable operation of this vehicle device, depending on a combination of the apps. As a result, the vehicle may be placed in a dangerous state. On this account, in terms of ensuring the safety of the vehicle, it is desirable that whether to approve each of the control requests for controlling the same vehicle device from the plurality of apps be determined appropriately.

PTL 2 described above discloses the following mobile terminal device. While walking, a user of this mobile terminal device may use a function, such as email, shooting with camera, television, or the Internet, that requires full use of the eyes (vision) and fingers (operation). This mobile termina device is capable of determining such a use to be a dangerous operation act for the user and thus preventing the aforementioned function from being displayed on the display.

Incidentally, a plurality of applications are assumed to control the same vehicle device included in a vehicle. In this case, although a single application alone does not place the vehicle in an unstable state, the vehicle may be placed in a dangerous state when the plurality of applications control the same vehicle device. On this account, it is desirable that whether to approve control by the plurality of applications over the same vehicle device be determined appropriately.

However, PTL 2 described above does not disclose a technique relating to control by a plurality of applications over the same device. To be more specific, PTL 2 described above does not disclose a technique relating to determination that is appropriately made as to whether to approve control requests for controlling the same vehicle device from the plurality of apps.

In response to this, the present inventors have diligently studied a control device and so forth capable of appropriately determining, for each of control requests for controlling the same vehicle device from a plurality of applications, whether to approve the control request. As a result, the present inventors have invented a control device and so forth described below. To be more specific, the present inventors have invented the control device and so forth that are capable of approving the control requests or blocking at least one of the control requests, based on whether a combination of operations by the plurality of apps places a vehicle in a dangerous state.

Thus, the present embodiment provides a control device, a control method, and a recording medium that are capable of appropriately determining, for each of control requests for controlling the same vehicle device from a plurality of apps, whether to approve the control request.

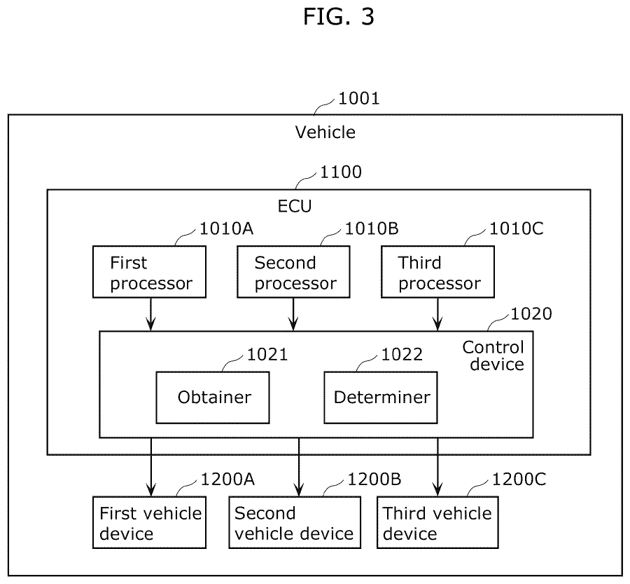

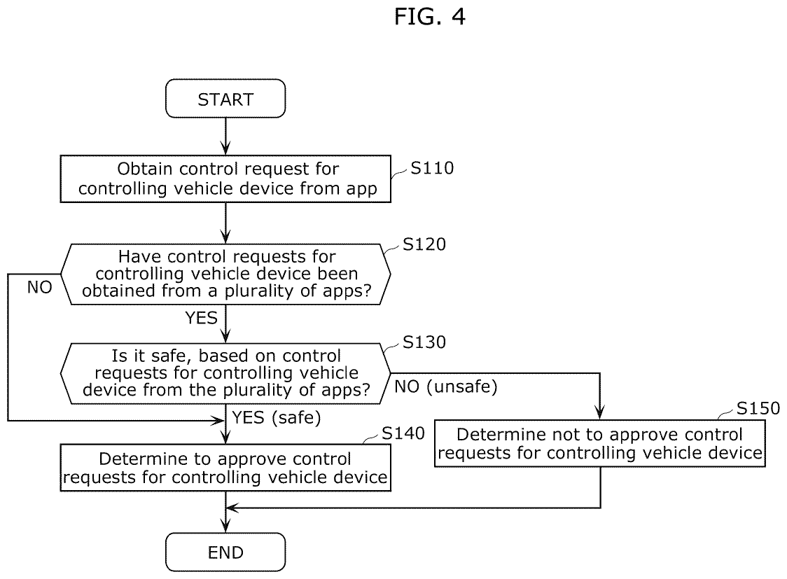

The following describes the control device according to the present embodiment with reference to FIG. 3 and FIG. 4.

### [2-1. Configuration of Control Device]

A configuration of a vehicle that includes the control device according to the present embodiment is first described with reference to FIG. 3. FIG. 3 is a block diagram illustrating a configuration of vehicle 1001 that includes control device 1020 according to the present embodiment. Note that FIG. 3 illustrates an exemplary functional configuration of control device 1020 and that the functional configuration of control device 1020 is not limited to the configuration illustrated in FIG. 3.

As illustrated in FIG. 3, vehicle 1001 includes ECU 1100, first vehicle device 1200A, second vehicle device 1200B, third vehicle device 1200C. Note that the number of vehicle devices included in vehicle 1001 is not limited to three and may be one or more.

ECU 1100 is an in-vehicle ECU that is included in vehicle 1001, and performs control on a vehicle device (equipment) included in vehicle 1001. For example, ECU 1100 is a device that includes a digital circuit, an analog circuit, and a communication circuit, such as a processor (microprocessor) and a memory. Examples of the memory include a ROM and a RAM. The memory is capable of storing a control program (computer program) executed by the processor. Each of various functions of ECU 1100 is achieved by the processor operating according to the control program (computer program). This control program includes the aforementioned user app and system app.

Note that vehicle 1001 includes a plurality of ECUs 1100. For example, the plurality of ECUs 1100 are communicatively connected with each other via an in-vehicle communication network (or more specifically, a bus connected to each of these ECUs). At least one of the plurality of ECUs 1100 may have the configuration illustrated in FIG. 3.

ECU 1100 may be an ECU (a so-called zone ECU) that is disposed in vehicle 1001 and that controls a vehicle device in a zone where this ECU is disposed. Alternatively, ECU 1100 may be a central ECU (a so-called integrated ECU) that combines a plurality of ECUs. To eliminate the issues of development period and cost that increase as an in-vehicle system increases in complexity, functions that have been conventionally installed separately on a plurality of ECUs are combined into the integrated ECU. The integrated ECU uses virtualization technique that allows a plurality of virtual computers (virtual machines: VM) to operate in one ECU.

ECU 1100 functions as control equipment that controls the vehicle device by executing at least either one of the installed system app or the installed user app. ECU 1100 includes first processor 1010A, second processor 1010B, third processor 1010C, and control device 1020. Note that the number of user apps included in ECU 1100 is not limited to three and may be two or more. The following describes an example where each of first processor 1010A, second processor 1010B, and third processor 1010C is a processor that executes a user app. Moreover, ECU 1100 may further include a processor (not shown) that executes the system app.

Each of first processor 1010A, second processor 1010B, and third processor 1010C is a processor that executes a user app different from the system app. To be more specific, first processor 1010A is the processor that executes a first user app, second processor 1010B executes a second user app, and third processor 1010C executes a third user app.

The user app is created by a company different from a manufacturer of the system app, for example. Each of first processor 1010A, second processor 1010B, and third processor 1010C is capable of controlling the vehicle device of vehicle 1001 by executing the user app. Each of first processor 1010A, second processor 1010B, and third processor 1010C outputs, to control device 1020, a control request for controlling the vehicle device of vehicle 1001. When control device 1020 approves the control request, the corresponding one of first processor 1010A, second processor 1010B, and third processor 1010C is allowed to control this vehicle device. The control request includes: identification information (such as an ID) identifying the vehicle device targeted for control; and a control detail. The first user app is an example of a first application. The second user app is an example of a second application. A set of the first user app, the second user app, and the third user app is an example of a plurality of user applications.

First processor 1010A, second processor 1010B, and third processor 1010C have functions for controlling the same vehicle device. Note that first processor 1010A, second processor 1010B, and third processor 1010C may further have functions for controlling respective vehicle devices that are different from each other.

As described above, ECU 1100 according to the present embodiment has the configuration that enables the plurality of user apps to operate. In other words, vehicle 1001 includes the plurality of user apps that control one vehicle device.

Control device 1020 is a processing device that performs monitoring (behavior monitoring) relating to the control by the plurality of user apps over the vehicle device. Control device 1020 determines whether to approve control requests from two or more processors among first processor 1010A, second processor 1010B, and third processor 1010C, based on the control requests from the two or more processors. Control device 1020 includes obtainer 1021 and determiner 1022. Hereinafter, the control request outputted when first processor 1010A executes the first user app is also referred to as the control request from the first user app, and the control request outputted when second processor 1010B executes the second user app is also referred to as the control request from the second user app.

Obtainer 1021 is a communication interface that obtains the control requests from the first user app, the second user app, and third user app. For example, obtainer 1021 obtains the control requests for controlling the same vehicle device from two or more user apps among the first user app, the second user app, and third user app. For example, obtainer 1021 includes a communication circuit (or a communication module).

Determiner 1022 determines, for each of the control requests for controlling the vehicle device from the plurality of user apps, whether to approve the control request, based on the control requests from the plurality of user apps. Determiner 33 determines, for each of the control requests from the plurality of user apps, whether to approve the control request, based on whether executions of the control requests place vehicle 1001 in a dangerous state (for example, a state where traveling of vehicle 1001 is dangerous). For example, when the executions of the control requests from the plurality of user apps are predicted to place vehicle 1001 in a dangerous state, determiner 33 determines not to approve at least one of the control requests from the plurality of user apps. When the executions of the control requests from the plurality of user apps are predicted to place vehicle 1001 in a dangerous state, determiner 1022 may determine to approve none of the plurality of control requests, or may determine to approve one or more of the plurality of control requests, based on preset priorities assigned to the user apps or control details. Note that a determination method used by determiner 1022 is described in detail later.

Each of first vehicle device 1200A, second vehicle device 1200B, and third vehicle device 1200C is an in-vehicle device that is communicatively connected to ECU 1100 via the in-vehicle communication network and that is controlled by ECU 1100. Each of first vehicle device 1200A, second vehicle device 1200B, and third vehicle device 1200C is a physical device included in vehicle 1001. Examples of first vehicle device 1200A, second vehicle device 1200B, and third vehicle device 1200C include a display device, a sound output device, an interior light, and a notification device. The display device may be included in a car navigation system or may be a rearview monitor, for example. For example, the sound output device may be included in the car navigation system, or may be an audio device. Furthermore, examples of first vehicle device 1200A, second vehicle device 1200B, and third vehicle device 1200C may also include a light (a headlight, for example), an electronic mirror, a power window, an air conditioner, and a lock-unlock device.

### [2-2. Operation of Control Device]

Next, an operation of control device 1020 having the configuration as above is described with reference to FIG. 4. FIG. 4 is a flowchart of the operation (a control method) performed by control device 1020 according to the present embodiment.

As illustrated in FIG. 4, obtainer 1021 obtains a control request for controlling a vehicle device from a user app (S110). Obtainer 1021 is capable of obtaining the control request from each of the first user app, the second user app, and the third user app. Note that obtainer 1021 may obtain the control request from the system app in Step S110.

Next, determiner 1022 determines whether control requests for controlling the vehicle device have been obtained from a plurality of apps (user apps in this example) (S120). Assume that, in Step S120, obtainer 1021 has obtained, while the vehicle device is executing the control request from one user app, a control request for controlling this vehicle device from another user app different from the one user app. In this case, determiner 1022 determines “YES” in Step S120 when at least one of: a case where obtainer 1021 has obtained the control requests for controlling the same vehicle device from the plurality of user apps within a predetermined time period; or a case where obtainer 1021 has obtained at least a predetermined number of control requests for controlling the same vehicle device from the plurality of user apps within a predetermined time period, is satisfied. Determining “YES” in Step S120 corresponds to that a predetermined condition is satisfied.

Next, when determiner 1022 has determined that the control requests for controlling the vehicle device have been obtained from the plurality of apps (the plurality of user apps in this example) (YES in S120), determiner 1022 determines whether vehicle 1001 is safe, based on the control requests for controlling the vehicle device from the plurality of apps (the plurality of user apps in this example) (S130). Determiner 1022 determines whether vehicle 1001 is safe, by integrating the control requests from the plurality of apps. Furthermore, when determiner 1022 has determined that the control requests for controlling the vehicle device have not been obtained from the plurality of apps (NO in S120), or more specifically, when the control request for controlling the vehicle device has been obtained from only one user app, determiner 1022 proceeds to Step S140.

The following are specific examples of the determination made by determiner 1022 as to whether it is safe.

For example, assume that obtainer 1021 has obtained, while the vehicle device is executing the control request from one user app, a control request for controlling this vehicle device from another user app different from the one user app. More specifically, assume that the predetermined condition is satisfied. In this case, determiner 1022 may determine not to approve the obtained control request for controlling the vehicle device. The following is the reason why the above determination is made. For example, assume that the vehicle device is a presentation device, such as a display device or a sound output device, and that while first information is being presented (being displayed or being sounded, for example), a control request including presentation of second information different from the first information is executed. In this case, it may be difficult for the driver to check the presented content and the information cannot be properly conveyed to the driver. This may place vehicle 1001 in a dangerous state. Here, the sound output device is taken as an example. When voice information announcing danger is overwritten by a user app that performs typical streaming correction, it is difficult to hear voice that announces danger.

When the vehicle device is a display device, each of the plurality of user apps has a function of controlling displaying of a screen that is to be checked by the driver of vehicle 1001. When the vehicle device is a sound output device, each of the plurality of user apps has a function of controlling sound output of vehicle 1001.

To be more specific, when the control request has been obtained from the second user app while first vehicle device 1200A is executing the control request from the first user app, determiner 1022 may determine that the predetermined condition is satisfied when a control target included in the control request is first vehicle device 1200A and thus may determine not to approve the control request for controlling the vehicle device. Note that when the plurality of control requests result in similar colors for background and display, low contrast between the displayed colors makes it difficult to view the presented content. Thus, when the background color and the display color are similar, determiner 1022 may determine that vehicle 1001 is not safe (for example, determiner 1022 may determine not to approve at least one of the plurality of control requests for controlling this vehicle device). For example, when the control requests for controlling the displaying of the screen have been obtained from the plurality of user apps, determiner 1022 may determine not to approve at least one of the control requests obtained from the plurality of user apps. Furthermore, when the control requests for controlling the sound output have been obtained from the plurality of user apps, determiner 1022 may determine not to approve at least one of the control requests obtained from the plurality of user apps.

Furthermore, for example, assume that obtainer 1021 has obtained the control requests for controlling the same vehicle device from the plurality of user apps within the predetermined time period (simultaneously, for example). More specifically, assume that the predetermined condition is satisfied. In this case, determiner 1022 may determine not to approve at least one of the plurality of control requests for controlling this vehicle device that have been obtained within the predetermined time period. The following is the reason why the above determination is made. For example, assume that the vehicle device is a presentation device, such as a display device or a sound output device, and that the control request for presenting first information and the control request for presenting second information different from the first information are executed within the predetermined time period (simultaneously, for example). In this case, it may be difficult for the driver to check the presented content and the information cannot be properly conveyed to the driver. This may place vehicle 1001 in a dangerous state.

To be more specific, when a time difference between times at which the plurality of control requests for controlling the same vehicle device are obtained is within a predetermined time period, determiner 1022 may determine that the predetermined condition is satisfied and thus determine not to approve at least one of the plurality of control requests. Here, the predetermined time period is preset. For example, when the plurality of control requests for controlling the same vehicle device have been obtained simultaneously (that is, the predetermined time period is virtually zero), determiner 1022 may determine that vehicle 1001 is not safe (for example, determiner 1022 may determine not to approve at least one of the plurality of control requests for controlling this vehicle device).

Furthermore, for example, assume that obtainer 1021 has obtained at least a predetermined number of the control requests for controlling the same vehicle device from the plurality of user apps within the predetermined time period. More specifically, assume that the predetermined condition is satisfied. In this case, determiner 1022 may determine not to approve at least one of the at least the predetermined number of control requests for controlling this vehicle device that have been obtained within the predetermined time period. The following is the reason why the above determination is made. For example, assume that the vehicle device is a display device and that the plurality of control requests are to notify (displaying in this example) some information. In this case, when the displaying changes in a short time period due to a combination of user apps, the driver is distracted and thus vehicle 1001 may be placed in a dangerous state.

When the vehicle device is a device, such as a display device, that has a notification function, each of the plurality of user apps has a function of controlling notification to the driver of vehicle 1001.

To be more specific, determiner 1022 counts the number of times the control request for controlling the same vehicle device has been obtained within the predetermined time period, and determines whether this counted number of times (in other words, the number of obtained control requests) within the predetermined time period is the predetermined number of times or more. When the counted number of times is the predetermined number of times or more, determiner 1022 may determine not to approve at least one of the plurality of control requests. Here, the predetermined time period is preset.

Furthermore, determiner 1022 may determine, for each of the control requests from the plurality of user apps, whether to the control request, based on the control details of the control requests from the plurality of user apps. More specifically, when the predetermined condition is satisfied and also another condition is satisfied, determiner 1022 may determine whether to approve the control requests. For example, when the control details of the plurality of control requests contradict each other, determiner 1022 may determine not to approve at least one of the plurality of control requests. For example, when the vehicle device is the interior light and the plurality of control details include turning on the interior light and turning off the interior light, determiner 1022 may determine not to approve at least one of the plurality of control requests. This is because when the combination of user apps causes the interior light to alternately turn on and off, it may be difficult for the driver to look ahead and thus vehicle 1001 may be placed in a dangerous state. Note that when the vehicle device is the interior light and the plurality of control details include only one of turning on the interior light or turning off the interior light, determiner 1022 may determine to approve the plurality of control requests. The control detail corresponding to turning on the interior light is an example of the control detail corresponding to brightening the interior light. The control detail corresponding to turning off the interior light is an example of the control detail corresponding to dimming the interior light.

When the vehicle device is the interior light, each of the plurality of user apps has at least either one of a control function of turning on the interior light of vehicle 1001 or a control function of turning off the interior light of vehicle 1001.

Furthermore, for example, when the vehicle device is the display device and each of the plurality of control details is to change a color scheme of a screen theme of the display device or to change the displayed content, determiner 1022 may determine not to approve at least one of the plurality of control requests. This is because when the color scheme changes multiple times during a short time period, the displayed content becomes difficult to view due to the balance with the display color. Thus, it may be difficult for the driver to view the displayed content and thus vehicle 1001 may be placed in a dangerous state. Note that the screen theme is used as a function enabling customization of desktop wallpaper, accent color, sound, and design of mouse cursor all at once, and is an example of the function of a user app.

Next, when determiner 1022 has determined, based on the plurality of control requests, that vehicle 1001 is safe (YES in S130), determiner 1022 determines to approve the control requests for controlling the vehicle device (S140). Then, determiner 1022 outputs the control requests to the vehicle device targeted for control. For example, determiner 1022 transfers the control requests to the vehicle device targeted for control.

As a result, when vehicle 1001 is safe, the control requests from the user apps are executed by the vehicle device targeted for control. Thus, the user values of the user apps can be increased while the safety of vehicle 1 is ensured. Note that when it is determined as “YES” in Step S130, this means that vehicle 1001 is determined to be safe.

Furthermore, when determiner 1022 has determined that, based on the plurality of control requests, vehicle 1001 is not safe (NO in S130), determiner 1022 determines not to approve the control requests (S150) and does not output the control requests to the vehicle device targeted for control. In other words, determiner 1022 prohibits outputting the control requests to the vehicle device targeted for control.

Note that, for example, when the plurality of control requests are obtained simultaneously, determiner 1022 may determine to approve only at least one of the control requests. For example, determiner 1022 may determine to approve one control request assigned higher priority among the plurality of control requests. The priorities assigned to the control requests may be preset. For example, a higher priority may be assigned to a control request for setting up an alarm or to a control request from a user app having a function of setting up an alarm. With this, the user value can be further increased as compared to the case where none of the control requests is approved.

In this way, control device 1020 monitors the control requests for controlling the vehicle device from the plurality of user apps. When the control requests for controlling the same vehicle device have been obtained from the plurality of user apps, control device 1020 is able to determine whether to approve these control requests based on the safety of vehicle 1001. When vehicle 1001 is predicted to be placed in a dangerous state, at least one of the control requests from the plurality of user apps is not executed. Hence, the safety of vehicle 1001 is ensured.

### OTHER EMBODIMENTS

Although the control device and the like according to one or more aspects of the present disclosure have been described based on the embodiments, the present disclosure is not limited to the embodiments. Those skilled in the art will readily appreciate that embodiments arrived at by making various modifications to the above embodiments or embodiments arrived at by selectively combining elements disclosed in the above embodiments without materially departing from the scope of the present disclosure may be included within one or more aspects of the present disclosure.

For example, although Embodiment 1 describes an example where vehicle 1 includes one ECU 100, the number of ECUs 100 included in vehicle 1 may be greater than one. For example, first processor 10A of a first ECU may control, via control device 30, a vehicle device targeted for control by a second ECU different from the first ECU. For example, a user app installed in the first ECU may be able to control a vehicle device targeted for control by the second ECU different from the first ECU.

For example, although Embodiment 2 describes an example where vehicle 1001 includes one ECU 1100, the number of ECUs 1100 included in vehicle 1001 may be greater than one. For example, first processor 1010A of a first ECU may control, via control device 1020, a vehicle device targeted for control by a second ECU different from the first ECU. For example, a user app installed in the first ECU may be able to control a vehicle device targeted for control by the second ECU different from the first ECU. In this case, a control device of the second ECU may make the determinations in Steps S120 and S130, based on the control request from the first ECU and the control request from the user app installed in this control device.

Furthermore, determiner 33 in Embodiment 1 may hold the control request determined to be disallowed in a storage (not shown). When the vehicle status changes into a state where this held control request is approvable, determiner 33 may approve this control request and cause a corresponding vehicle device to execute this control request.

Furthermore, although Embodiment 1 describes an example where determiner 33 determines “YES” or “NO” in Step S30, this is not intended to be limiting. Determiner 33 may determine “YES”, “NO”, or a restriction mode. In the restriction mode, the execution of the control request is restricted, for example. For example, when determiner 33 determines not to approve the control request from the user app and a specific condition is satisfied, determiner 33 may determine to approve the execution of this control request with restriction. For example, assume that vehicle 1 is moving in reverse, a part of the rearview monitor displays a rear view, and the control request from the user app includes superimposing of a display on the rearview monitor of vehicle 1. In this case, determiner 33 may determine to superimpose the display in an area of the rearview monitor other than the area where the rear view is displayed. An example of the specific condition is that the rear view is displayed only in a partial area of the display screen of the rearview monitor, or more specifically, that a display area of the rearview monitor has free space. Furthermore, the superimposing of the display in the area other than the area where the rear view is displayed is an example of executing the control request with restriction. Furthermore, for example, when determiner 33 determines to approve the control request from the user app and the specific condition is satisfied, determiner 33 may determine to approve the execution of this control request with restriction.

Furthermore, for example, although Steps S120 and S130 are executed in response to the plurality of control requests from the user apps in Embodiment 2, this is not intended to be limiting. For example, Steps S120 and S130 may be executed in response to the plurality of control requests from the system app. Alternatively, Steps S120 and S130 may be executed in response to the plurality of control requests from the system app and the user app.

Each of the constituent elements in each of Embodiments 1 and 2 described above may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

An order of performing the steps in each of the flowcharts is an example for explaining the present disclosure in detail. The steps may be performed in different orders. Different steps among the steps may be performed simultaneously, in other words, in parallel. It is not necessary to perform a part of the steps may not be performed.

The dividing of the functional blocks in each of the block diagrams is one example. It is possible that a plurality of functional blocks are implemented into a single functional block, that a single functional block is divided into a plurality of functional blocks, and that a function executed by a functional block is partially executed by another functional block. Furthermore, similar functions of a plurality of functional blocks may be executed by a single hardware or software in parallel or by time division.

Control device 30 according to Embodiment 1 may be implemented into a single device or a plurality of devices. If control device 30 is implemented into a plurality of devices, how to allocate the constituent elements included in control device 30 to the plurality of devices is not limited. Furthermore, if control device 30 is implemented into a plurality of devices, a communication method performed between the plurality of devices is not limited to a particular method. It may be wireless communication or wired communication. It is also possible to combine wireless communication and wired communication between the plurality of devices.

Control device 1020 according to Embodiment 2 may be implemented into a single device or a plurality of devices. If control device 1020 is implemented into a plurality of devices, how to allocate the constituent elements included in control device 1020 to the plurality of devices is not limited. Furthermore, if control device 1020 is implemented into a plurality of devices, a communication method performed between the plurality of devices is not limited to a particular method. It may be wireless communication or wired communication. It is also possible to combine wireless communication and wired communication between the plurality of devices.

It should be noted that each of the constituent elements described in each of the above embodiments may be implemented into software, or typically into a Large Scale Integration (LSI) which is an integrated circuit. These constituent elements may be integrated separately, or a part or all of them may be integrated into a single chip. Note that here, the terminology “LSI” is used, but depending on the degree of integration, the circuit may also referred to as IC, system LSI, super LSI circuit, or ultra LSI circuit. Moreover, the method of circuit integration is not limited to LSI. Integration may be implemented into a specialized circuit (a general-purpose circuit for executing a special program) or a general purpose processor. After the LSI circuit is manufactured, a field programmable gate array (FPGA) or a reconfigurable processor capable of reconfiguring the connections and settings of the circuit cells in the LSI circuit may be used. Further, if an integrated circuit technique that replaces LSI emerges from advances in or derivations of semiconductor technique, integration of functional blocks using such technique may also be used.

The system LSI is a multi-functional LSI in which a plurality of elements are integrated into a single chip. An example of such a system LSI is a computer system including a microprocessor, a ROM, a Random Access Memory (RAM), and the like. The ROM stores a computer program. The microprocessor operates according to the computer program to cause the system LSI to execute its function.

Another aspect of the present disclosure may be a computer program for causing a computer to execute each of the characteristic steps included in the control method indicated in any one of FIG. 2 or FIG. 4.

For example, the program may be a program to be executed by a computer. Another aspect of the present disclosure may a non-transitory computer-readable recording medium having recorded thereon such a program. For example, such a program may be recorded onto the recording medium and distributed. For example, it is possible that such a distributed program is installed in a device having another processor and executed by the other processor so as to allow the other processor to perform the above-described steps of the processing.

### APPENDIX

The embodiments above disclose the following techniques.

### (Technique 1)

A control device provided to a vehicle, the control device including: a first obtainer that obtains, from a user application, a control request for controlling a vehicle device of the vehicle; a second obtainer that obtains a vehicle status of the vehicle; and a determiner that determines whether to approve the control request, based on the vehicle status.

With this, whether to approve the control request from the user application can be determined based on the vehicle status. Thus, whether to approve the control request for controlling the vehicle device from the user application can be determined more appropriately. For example, as compared to the case where vehicle information is not used, whether to approve the control request for controlling the vehicle device from the user application can be determined appropriately.

### (Technique 2)

The control device according to Technique 1, wherein the determiner determines whether to approve the control request, based on whether execution of the control request in the vehicle status places the vehicle in a dangerous state.

With this, whether to approve the control request from the user application can be determined based on whether the vehicle is to be placed in a dangerous state. Thus, the vehicle can be prevented from being placed in a dangerous state, by not approving the control request, for example. Hence, whether to approve the control request for controlling the vehicle device from the user application can be determined more appropriately.

### (Technique 3)

The control device according to Technique 2, wherein when the execution of the control request in the vehicle status places the vehicle in the dangerous state, the determiner determines not to approve the control request.

With this, the control request is not approved when the vehicle is to be placed in a dangerous state. Hence, the safety of vehicle 1 can be ensured more reliably.

### (Technique 4)

The control device according to any one of Techniques 1 to 3, wherein the vehicle status includes at least one of a speed, a position, a steering angle, a traveling direction, a surrounding environment, or a traveling mode of the vehicle.

With this, whether to approve the control request from the user application can be determined using information obtainable from a sensor that is included in the vehicle, the information being on at least one of the speed, the position, the steering angle, the traveling direction, the surrounding environment, or the traveling mode of the vehicle. Hence, whether to approve the control request for controlling the vehicle from the user application can be determined more appropriately without increasing the complexity of the configuration of the vehicle.

### (Technique 5)

The control device according to any one of Techniques 1 to 4, wherein the user application is different from an application that is preinstalled in the vehicle.

With this, whether to approve the control request from the application different from the application preinstalled in the vehicle can be determined more appropriately.

### (Technique 6)

The control device according to any one of Techniques 1 to 5, wherein when the vehicle status indicates that the vehicle is traveling and the control request includes beam switching of a headlight of the vehicle, the determiner determines not to approve the control request.

With this, the control request for the beam switching of the headlight is executable when the vehicle is safe. Hence, while the safety of the vehicle is ensured, the user value of the user application can be increased.

### (Technique 7)

The control device according to any one of Techniques 1 to 6, wherein when a speed of the vehicle is greater than or equal to a threshold value and the control request includes beam switching of a headlight of the vehicle, the determiner determines not to approve the control request.

With this, the control request for the beam switching of the headlight is executable when the vehicle is safe. Hence, while the safety of the vehicle is ensured, the user value of the user application can be increased.

### (Technique 8)

The control device according to any one of Techniques 1 to 7, wherein when the vehicle status indicates that the vehicle is moving in reverse and the control request includes superimposing a display item on a rearview monitor of the vehicle, the determiner determines not to approve the control request.

With this, the control request for superimposing the display on the rearview monitor is executable when the vehicle is safe. Hence, while the safety of the vehicle is ensured, the user value of the user application can be increased.

### (Technique 9)

The control device according to any one of Techniques 1 to 8, wherein when the vehicle status indicates that the vehicle is traveling in a dark environment and the control request includes turning on an interior light of the vehicle, the determiner determines not to approve the control request.

With this, the control request for turning on the interior light of the vehicle is executable when the vehicle is safe. Hence, while the safety of the vehicle is ensured, the user value of the user application can be increased.

### (Technique 10)

The control device according to any one of Techniques 1 to 9, wherein when the vehicle status indicates that the vehicle is traveling and the control request includes displaying an image to a driver of the vehicle, the determiner determines not to approve the control request.

With this, the control request for displaying the image to the driver of the vehicle is executable when the vehicle is safe. Hence, while the safety of the vehicle is ensured, the user value of the user application can be increased.

### (Technique 11)

The control device according to any one of Techniques 1 to 10, wherein the vehicle includes an electronic mirror switchable between a video displaying function and a mirror function, and when the vehicle status indicates that the vehicle is traveling and the control request includes turning on the mirror function of the electronic mirror, the determiner determines not to approve the control request.

With this, the control request for turning on the mirror function of the electronic mirror is executable when the vehicle is safe. Hence, while the safety of the vehicle is ensured, the user value of the user application can be increased.

### (Technique 12)

A control method to be executed by a control device provided to a vehicle, the control method comprising: obtaining, from a user application, a control request for controlling a vehicle device of the vehicle; obtaining a vehicle status of the vehicle; and determining whether to approve the control request, based on the vehicle status.

With this, the same advantageous effects as those achieved by the control device described above can be achieved.

### (Technique 13)

A non-transitory computer-readable recording medium having recorded thereon a computer program for causing a computer to execute the control method according to Technique 12.

With this, the same advantageous effects as those achieved by the control device described above can be achieved.

### (Technique 14)

The control device according to any one of Techniques 1 to 11, wherein the vehicle includes a plurality of applications for controlling the vehicle device of the vehicle, the plurality of applications including the user application, the first obtainer obtains, from two or more applications among the plurality of applications, a plurality of control requests for controlling the vehicle device, the plurality of control requests each being the control request, and when the plurality of control requests obtained from the two or more applications satisfy a predetermined condition, the determiner determines, for each of the plurality of control requests, whether to approve the control request, based on the plurality of control requests.

With this, when the predetermined condition is satisfied, whether to approve each of a plurality of control requests can be determined based on the plurality of control requests that satisfy the predetermined condition. More specifically, this determination can be made based on the plurality of control requests. Hence, whether to approve each of a plurality of control requests for controlling the same vehicle device from a plurality of applications can be determined appropriately.

### (Technique 15)

The control device according to Technique 14, wherein the determiner determines, for each of the plurality of control requests obtained from the two or more applications, whether to approve the control request, based on whether executions of the plurality of control requests place the vehicle in a dangerous state.

With this, whether to approve each of a plurality of control requests from a plurality of user applications can be determined based on whether a combination of the plurality of control requests places the vehicle in a dangerous state. Thus, the vehicle can be prevented from being placed in a dangerous state, by not approving at least one of the control requests, for example. Hence, whether to approve each of a plurality of control requests for controlling the vehicle device from a plurality of user applications can be determined appropriately.

### (Technique 16)

The control device according to Technique 14, wherein when the executions of the plurality of control requests obtained from the two or more applications place the vehicle in a dangerous state, the determiner determines not to approve at least one of the plurality of control requests.

With this, at least one of a plurality of control requests is not approved when the vehicle is to be placed in a dangerous state. Hence, in terms of ensuring the safety of the vehicle more reliably, whether to approve each of a plurality of control requests can be determined appropriately.

### (Technique 17)

The control device according to any one of Techniques 14 to 16, wherein the determiner determines, for each of the plurality of control requests obtained from the two or more applications, whether to approve the control request, based on control details of the plurality of control requests.

With this, whether to approve each of a plurality of control requests from a plurality of applications can be determined further based on the control details of the control requests. For example, when the vehicle is to be placed in a dangerous state depending on a combination of the control details, at least one of the control requests can be rejected. Hence, in terms of ensuring the safety of the vehicle more reliably, whether to approve each of a plurality of control requests can be determined more appropriately.

### (Technique 18)

The control device according to any one of Techniques 14 to 17, wherein the plurality of applications include a first application and a second application, and the predetermined condition includes that the first obtainer obtains the control request for controlling the vehicle device from the second application while the vehicle device is executing the control request from the first application.

With this, the control request from the second application can be prevented from being executed while the control request from the first application is being executed. More specifically, the vehicle can be prevented from being placed in a dangerous state due to the two control requests executed simultaneously. Hence, in terms of preventing the vehicle from being placed in a dangerous state, whether to approve each of a plurality of control requests can be determined appropriately.

### (Technique 19)

The control device according to any one of Techniques 14 to 18, wherein the predetermined condition includes that the first obtainer obtains the plurality of control requests for controlling the vehicle device from the two or more applications within a predetermined time period.

With this, when a plurality of control requests for controlling the vehicle device have been obtained within the predetermined time period, executions of all of the control requests obtained can be prevented. Hence, in terms of preventing the vehicle from being placed in a dangerous state, whether to approve each of a plurality of control requests can be determined appropriately.

### (Technique 20)

The control device according to any one of Techniques 14 to 19, wherein the predetermined condition includes that the first obtainer obtains at least a predetermined number of control requests for controlling the vehicle device from the two or more applications within a predetermined time period.

With this, when at least the predetermined number of control requests have been obtained within the predetermined time period, executions of all of these control requests obtained can be prevented. Hence, in terms of preventing the vehicle from being placed in a dangerous state, whether to approve each of a plurality of control requests can be determined appropriately.

### (Technique 21)

The control device according to any one of Techniques 14 to 20, wherein each of the plurality of applications has a function of controlling display of a screen that is to be checked by a driver of the vehicle, and when control requests for controlling display of the screen are obtained from two or more applications among the plurality of applications, the determiner determines not to approve at least one of the control requests obtained from the two or more applications.

With this, the display can be prevented from being difficult to view due to the executions of a plurality of control requests obtained from a plurality of applications.

### (Technique 22)

The control device according to any one of Techniques 14 to 21, wherein each of the plurality of applications has a function of controlling sound output of the vehicle, and when control requests for controlling sound output of the vehicle are obtained from two or more applications among the plurality of applications, the determiner determines not to approve at least one of the control requests obtained from the two or more applications.

With this, the voice can be prevented from being difficult to hear due to the executions of a plurality of control requests from a plurality of applications.

### (Technique 23)

The control device according to any one of Techniques 14 to 22, wherein each of the plurality of applications has a function of turning on and off of an interior light of the vehicle, and when control requests for turning on and off the interior light are obtained from two or more applications among the plurality of applications, the determiner determines not to approve at least one of the control requests obtained from the two or more applications.

With this, the user can be prevented from having difficulty in looking ahead due to the frequent switching on and off of the interior light.

### (Technique 24)

The control device according to any one of Techniques 14 to 23, wherein each of the plurality of applications has a function of controlling notification to a driver of the vehicle, and when at least a predetermined number of control requests for controlling notifications to the driver are obtained from two or more applications among the plurality of applications within a predetermined time period, the determiner determines not to approve at least one of the control requests obtained from the two or more applications.

With this, the user is prevented from being less attentive to driving when checking notifications from a plurality of applications.

### (Technique 25)

A control method to be executed by a control device provided to a vehicle, the vehicle including a plurality of applications for controlling a vehicle device of the vehicle, the control method comprising: obtaining, from two or more applications among the plurality of applications, a plurality of control requests for controlling the vehicle device, the plurality of control requests each being the control request; and when the plurality of control requests obtained from the two or more applications satisfy a predetermined condition, determining, for each of the plurality of control requests, whether to approve the control request, based on the plurality of control requests.

With this, the same advantageous effects as those achieved by the control device described above can be achieved.

### (Technique 26)

A non-transitory computer-readable recording medium having recorded thereon a computer program for causing a computer to execute the control method according to technique 25.

With this, the same advantageous effects as those achieved by the control device described above can be achieved.

The general and specific aspects according to the above-described embodiments may be implemented to a system, a method, an integrated circuit, a computer program, or a non-transitory computer-readable recording medium such as a Compact Disc-Read Only Memory (CD-ROM), or may be any combination of them. The program may be stored in the recording medium beforehand, or provided to the recording medium via a wide area network such as the Internet.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Applications Nos. 2024-101693 filed on Jun. 25, 2024 and 2024-101725 filed on Jun. 25, 2024.

### INDUSTRIAL APPLICABILITY

The present disclosure is useful to a control device that is included in a vehicle.

1. A control device provided to a vehicle, the control device comprising:
a first obtainer that obtains, from a user application, a control request for controlling a vehicle device of the vehicle;
a second obtainer that obtains a vehicle status of the vehicle; and
a determiner that determines whether to approve the control request, based on the vehicle status.

2. The control device according to claim 1,
wherein the determiner determines whether to approve the control request, based on whether execution of the control request in the vehicle status places the vehicle in a dangerous state.

3. The control device according to claim 2,
wherein when the execution of the control request in the vehicle status places the vehicle in the dangerous state, the determiner determines not to approve the control request.

4. The control device according to claim 1,
wherein the vehicle status includes at least one of a speed, a position, a steering angle, a traveling direction, a surrounding environment, or a traveling mode of the vehicle.

5. The control device according to claim 1,
wherein the user application is different from an application that is preinstalled in the vehicle.

6. The control device according to claim 1,
wherein when the vehicle status indicates that the vehicle is traveling and the control request includes beam switching of a headlight of the vehicle, the determiner determines not to approve the control request.

7. The control device according to claim 1,
wherein when a speed of the vehicle is greater than or equal to a threshold value and the control request includes beam switching of a headlight of the vehicle, the determiner determines not to approve the control request.

8. The control device according to claim 1,
Wherein when the vehicle status indicates that the vehicle is moving in reverse and the control request includes superimposing a display item on a rearview monitor of the vehicle, the determiner determines not to approve the control request.

9. The control device according to claim 1,
wherein when the vehicle status indicates that the vehicle is traveling in a dark environment and the control request includes turning on an interior light of the vehicle, the determiner determines not to approve the control request.

10. The control device according to claim 1,
wherein when the vehicle status indicates that the vehicle is traveling and the control request includes displaying an image to a driver of the vehicle, the determiner determines not to approve the control request.

11. The control device according to claim 1,
wherein the vehicle includes an electronic mirror switchable between a video displaying function and a mirror function, and
when the vehicle status indicates that the vehicle is traveling and the control request includes turning on the mirror function of the electronic mirror, the determiner determines not to approve the control request.

12. The control device according to claim 1,
wherein the vehicle includes a plurality of applications for controlling the vehicle device of the vehicle, the plurality of applications including the user application,
the first obtainer obtains, from two or more applications among the plurality of applications, a plurality of control requests for controlling the vehicle device, the plurality of control requests each being the control request, and
when the plurality of control requests obtained from the two or more applications satisfy a predetermined condition, the determiner determines, for each of the plurality of control requests, whether to approve the control request, based on the plurality of control requests.

13. The control device according to claim 12,
wherein the determiner determines, for each of the plurality of control requests obtained from the two or more applications, whether to approve the control request, based on whether executions of the plurality of control requests place the vehicle in a dangerous state.

14. The control device according to claim 13,
wherein when the executions of the plurality of control requests obtained from the two or more applications place the vehicle in a dangerous state, the determiner determines not to approve at least one of the plurality of control requests.

15. The control device according to claim 12,
wherein the determiner determines, for each of the plurality of control requests obtained from the two or more applications, whether to approve the control request, based on control details of the plurality of control requests.

16. The control device according to claim 12,
wherein the plurality of applications include a first application and a second application, and
the predetermined condition includes that the first obtainer obtains the control request for controlling the vehicle device from the second application while the vehicle device is executing the control request from the first application.

17. The control device according to claim 12,
wherein the predetermined condition includes that the first obtainer obtains the plurality of control requests for controlling the vehicle device from the two or more applications within a predetermined time period.

18. The control device according to claim 12,
wherein the predetermined condition includes that the first obtainer obtains at least a predetermined number of control requests for controlling the vehicle device from the two or more applications within a predetermined time period.

19. A control method executed by a control device provided to a vehicle, the control method comprising:
obtaining, from a user application, a control request for controlling a vehicle device of the vehicle;
obtaining a vehicle status of the vehicle; and
determining whether to approve the control request, based on the vehicle status.

20. A non-transitory computer-readable recording medium having recorded thereon a computer program for causing a computer to execute the control method according to claim 19.
